(19) United States
(12) Patent Application Publication
(10) Pub. No.: US 2003/0130876 A1
(43) Pub. Date: Jul. 10, 2003

(54) Production with accuracy

(76) Inventors: Cheng-Ju Chen, Taipei (TW); Yi-Ming Liao, Taipei (TW); Junh-Hsien Tu, Taipei (TW)

Correspondence Address: BIRCH STEWART KOLASCH & BIRCH, PO BOX 747, FALLS CHURCH, VA, 22040-0747, US

(21) Appl. No.: 10/038,906

(22) Filed: Jan. 8, 2002

(51) Int. Cl. G06F 17/60

(52) U.S. Cl. 705/7; 705/22

(57) ABSTRACT

A method of production with accuracy aims at resolving the problem of not being able to distinguish actual demands of materials from forecast demands of materials by the material management system in the manufacturing industry. The material requirements planning server manages and controls all orders of inventory stocks to separately manage actual demands and forecast demands to achieve the objects of decreasing materials in the facility, reducing the risk of purchasing materials by enterprises, and increasing profit margins of enterprises.

### BACKGROUND OF THE INVENTION

1. Field of the Invention

The invention relates to a method of managing material requirements, and particularly a method that is capable of controlling and managing forecast orders and production orders on a material requirement system in the manufacturing industry to achieve production with accuracy.

2. Related Art

With most enterprises and product manufacturers there are many ways to increase profit margins, and managing costs is one of the ways. Moreover, management of material costs among cost categories is a matter of interest to enterprises. To satisfy required product quantities of clients or end users, those enterprises and product manufacturers have to prepare sufficient materials for maintaining normal processes of production. The inability to maintain sufficient stock inventory would suspend the operation of production lines, so that finished goods from productions can not be delivered on time. This may cause the loss of potential commercial opportunities, cause an imbalance between supply and demand (disequilibrium), or reduce, even lose, market shares to those enterprises and product manufacturers. On the other hand, overstocking would cause a hoard of cash funds, difficulties in circulating capital, an increase in management of costs, and the loss of margin profits from invisible risks of changeable product markets to those enterprises and product manufacturers.

Daily faced problems to the manufacturing industry include: what parts or components need to be purchased, how to plan production schedules after purchasing material items, how to arrange delivery of finished goods from production, how to manage excess/surplus stock, etc. For example, forecast orders and production orders are not the same thing, and even a production order could possibly change without notice. Therefore, loss due to a stock-out or excess/surplus stock results from mistaken list making and incorrect materials preparation. Nevertheless, the current material requirement system still has the following drawbacks: (forecast orders and production orders are simultaneously sent to the system, however, the system can not distinguish forecast orders from production orders when forecast orders are more than production orders, finished goods produced by facilities, though, can meet requirements of production orders, it would cause a glut in the stock house/inventory center, due to misestimated forecast orders.

On the contrary, a large quantity of production orders from clients may be unsatisfying if existing inventory is insufficient to meet customer requirements, and may even cause the loss of a breach. Therefore, overstocking or understocking would, more or less, cause inconvenience of manufacturers and further increase costs.

Hence, a method of managing material requirements in the manufacturing industry has become a heavily focused subject.

### SUMMARY OF THE INVENTION

In view of the foregoing, the invention aims at resolving the preceding disadvantages to provide a method for accurate production. The primary objects of the invention is to aim at controlling and managing all material orders through the material requirements planning server to separately deliver production orders and forecast orders for the material requirements planning server to process. During the processing, the material requirements planning server utilizes storage media to store processed information, generates statuses of production and material shortage of the day, and forecast statuses of upcoming productions and upcoming stock-outs to decision makers for reference. The object of the invention is to effectively achieve a balance between forecast orders and production orders, reduce the risk of purchasing materials by enterprises, and decrease a glut in inventory to heighten profit margins.

The disclosed accurate productions method according to the invention at least consists of: delivering a production order of the day to the material requirements planning server for calculations, generating an actual purchase order through the material requirements planning server, calculating the difference of the production order and requirement of a forecast order to generate a forecasted purchase order, then calculating the production and the shortage of the day at the enterprise end, and forecasting the upcoming production and upcoming shortage status.

The foregoing, as well as additional objects, features and advantages of the invention will be more readily apparent from the following detailed description, which proceeds with reference to the accompanying drawings. Specific structures and functional details disclosed hereunder are not to be interpreted as limiting, but merely as a basis for the claims and as a representative basis for teaching one skilled in the art to variously employ the invention.

### BRIEF DESCRIPTION OF THE DRAWINGS

FIG. 1 is a schematic representation of presently known processes.

FIG. 2-a is a schematic representation of the operation of the invention.

FIG. 2-b is a schematic representation of the operation of the invention.

FIG. 2-c is a schematic representation of the operation of the invention.

FIG. 3 is a flowchart representation of the accurate production method according to the invention.

### DETAILED DESCRIPTION OF THE INVENTION

This invention proposes a method for accurate productions. In particular, the method, based on the advocacy of the up-to-date Business Process Re-Engineer (BPR), mainly aims at improving effective utilization and management of enterprise resources, re-engineering working processes of managing orders of material requirements, to decrease the risk of inventory and reduce operation costs of the organization.

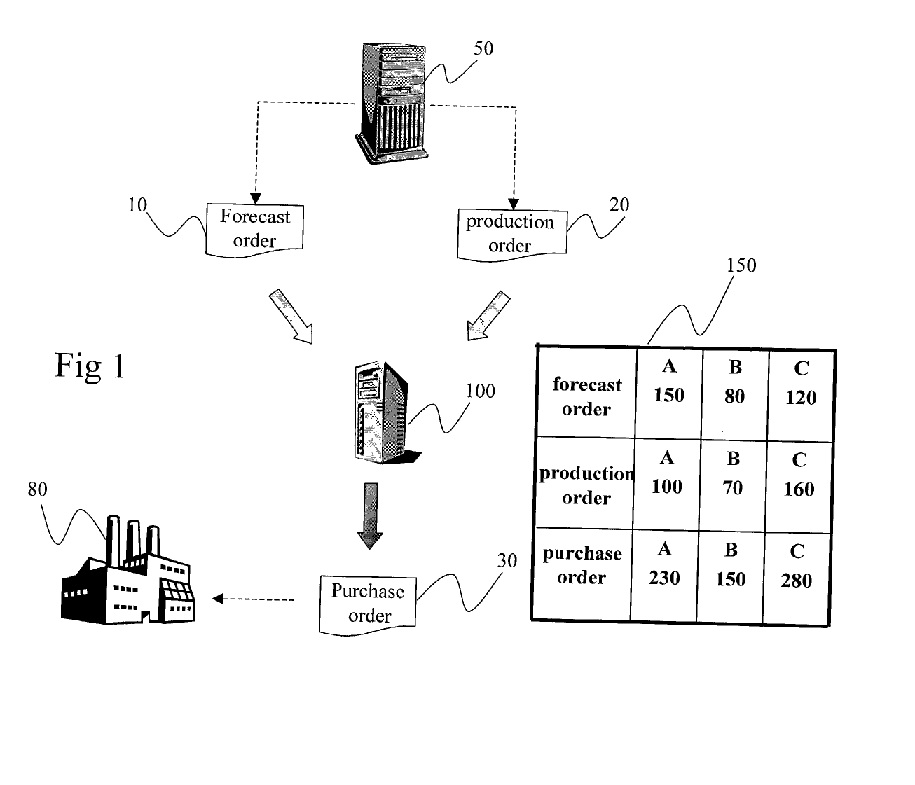

Before describing the invention, FIG. 1, which is a schematic representation of the presently known technology, is introduced hereunder.

In the past, the Enterprise Resource Planning (ERP) server 50 predicted forecast orders 10 at a fixed time interval, received production orders 20 from the client ends, delivered both the forecast orders 10 and production orders 20 to the material requirements planning server 100, and placed a purchase order 30. The relationships between a forecast order 10, a production order 20 and a purchase order 30 were described on the order form 150, on which the quantity of the purchase order 30 was equal to the sum of the forecast order 10 and the production order 20. The advantage of this method was that manufacturers did not need to worry that materials in inventory might not satisfy orders from clients. However, the purchased quantities usually far exceeded what a manufacturer needed to overstock in the facility 80.

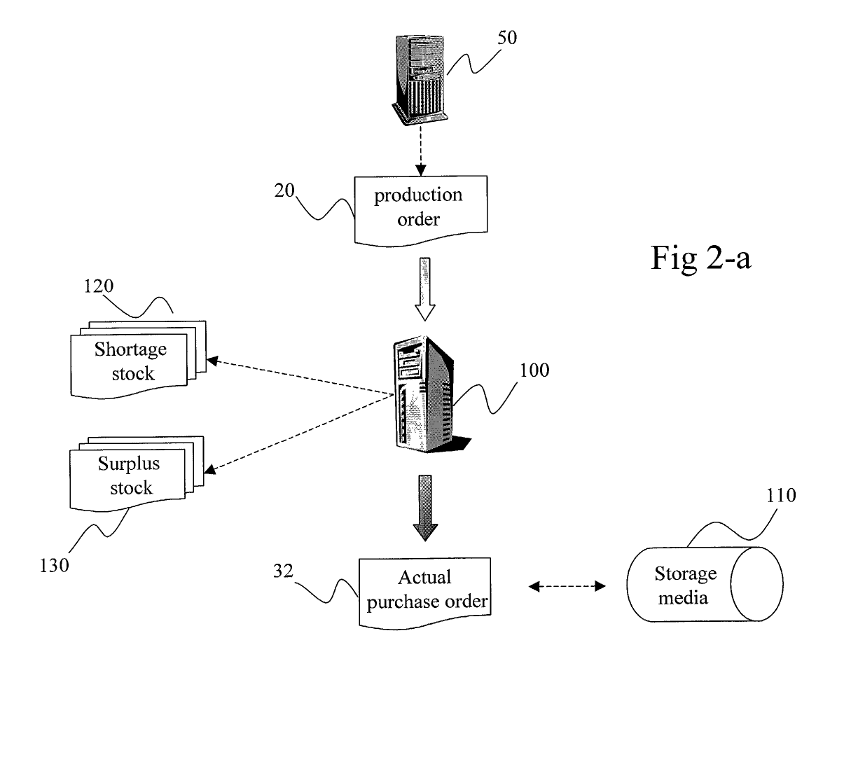

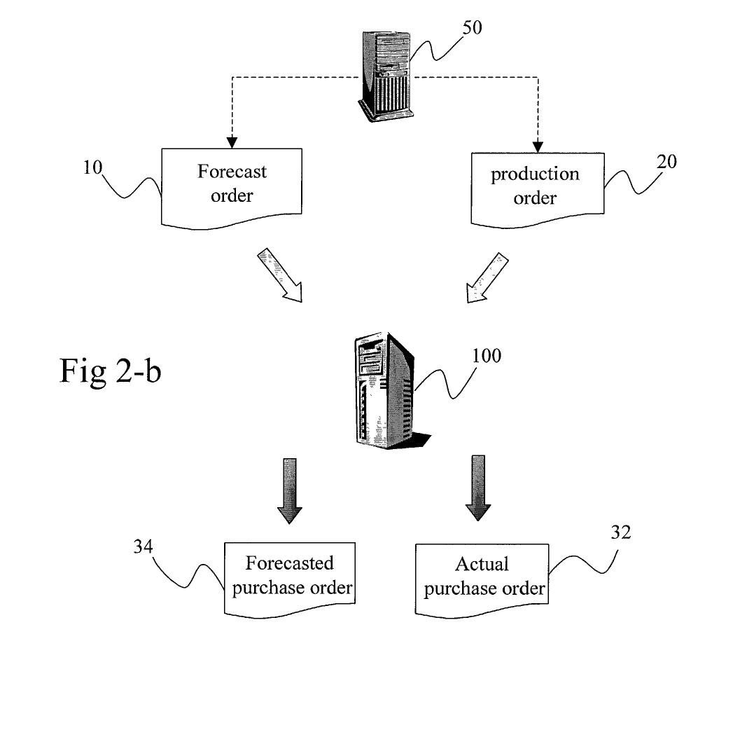

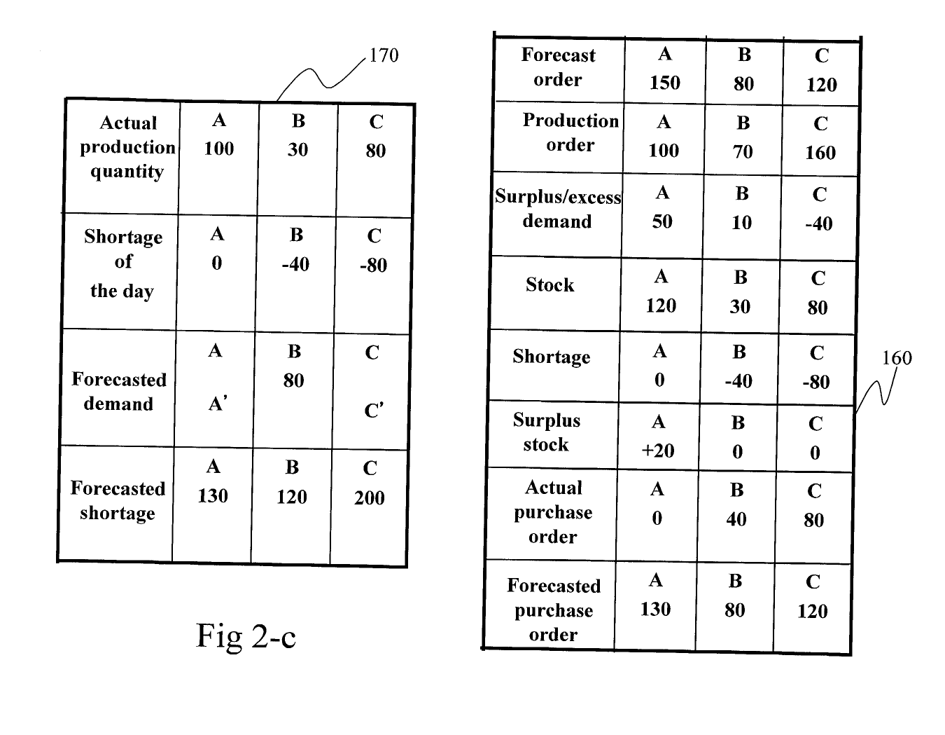

The feasibility and practicality of the invention will be elaborated by means of an embodiment depicted in the following. FIGS. 2-a, 2-b, 2-c are schematic representations of the operation of the invention. Details are provided hereunder.

First of all, just as with the known technology, the Enterprise Resource Planning (ERP) server 50 receives a forecast order 10 and a production order 20, then delivers the production order 20 to the material requirements planning server 100 for processing. The material requirements planning server 100 compares the quantity of that production order 20 with materials in inventory of a facility 80. When the quantity of inventory in the facility 80 exceeds that of the production order 20, surplus stock 130 is generated. When materials in inventory of the facility 80 are less than the quantity of the production order 20, a shortage 120 is generated. An actual purchase order 32, which relates to required materials of the shortage 120, is then generated through the material requirements planning server 100 and stored on the storage media 110 with a marker to avoid being re-calculated when the production order 20 is processed the next time. Subsequently, with reference to FIG. 2-b, the Enterprise Resource Planning (ERP) server 50 delivers the forecast order 10, together with the production order 20, to the material requirements planning server 100, which calls that actual purchase order 32 from the storage media 110 where the actual purchase order 32 had been previously saved. The material requirements planning server 100 then generates a forecasted purchase order 34, which is the difference in quantity of the forecast order 10 and the surplus material 130. The operation generates the following numbers, which are defined on the order forms 160 and 170 hereunder.

1. a surplus/excess demand: the difference of a forecast order 10 deducted from a production order 20.

2. a shortage (stock-out): the negative quantity of inventory stock deducted from a production order 20.

3. a surplus stock: the positive quantity of inventory stock deducted from a production order 20.

4. an actual purchase order: the quantity of a shortage (stock-out).

5. a forecasted purchase order: the quantity of a forecast order 10 deducted from a surplus stock.

6. an actual production quantity: a quantity is either equal to the inventory stock where there is a shortage, or to a production order 20 where there is a surplus stock.

7. a shortage of the day: is the quantity of a stock-out.

8. a forecasted demand: a quantity is either equal to a forecast order 10 when a surplus/excess demand is within a reasonable range, or to an average number, which is calculated from received production orders 10 over a specified future time period and is called by the material requirements planning sever 100 when a surplus/excess demand is over a reasonable range. (A specified future time period relates to a time that is set by the material requirements planning sever 100 for proceeding integration of orders upon requests of various client ends.)

9. a forecasted shortage: is the sum of an actual purchase order and a forecasted purchase order.

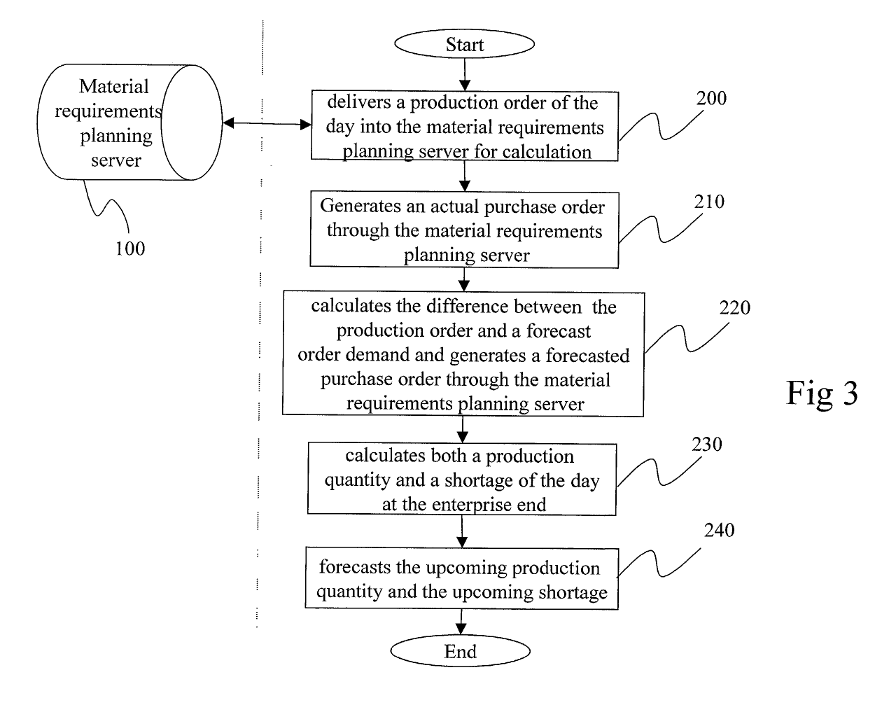

FIG. 3, a flowchart representation of the accurate production method according to the invention. It is described in detail hereunder.

First, a production order 20 of the day is delivered to the material requirements planning sever 100 for calculation (step 200), which is a method based on the contrast between a production order 20 and inventory stock in the facility 80 to generate quantities of a surplus stock and of a shortage. The aforementioned is not retold herein. Subsequently, the material requirements planning sever 100 generates an actual purchase order 32 (step 210), which is the amount of the shortage and is stored on a storage media 110 with a marker to avoid being calculated again when the production order 20 is processed the next time. The material requirements planning sever 100 then generates the difference between the production order 20 and the forecast order 10, as well as a forecasted purchase order (step 220), which is the difference between a forecast order 10 and a surplus stock 130. The material requirements planning sever 100 calculates a production quantity and a shortage of the day (step 230), which both add up to the amount of the production order 20, and forecasts the production quantity and the shortage in the future (step 240). The production quantity in the future is the average calculated from received production orders at a predetermined interval through the material requirements planning sever 100. The predetermined interval herein relates to a time, which is set by the material requirements planning sever 100 for proceeding integration of orders upon requests of various clients; whereas the shortage in the future is the amount of an actual purchase order 32 and a forecasted purchase order 34.

The respective meanings of the aforementioned forecast order 10 and production order 20 are: a forecast order 10 is generated through the material requirements planning sever 100 based on procurement records provided by a client end to forecast the replenishment of quantities and categories of required materials at a predetermined interval at the enterprise end; whereas a production order 20 relates to a build order placed by a client end at a predetermined interval.

The aforementioned facility 80 is to distinguish production demands according to various product prototypes/modules, and to implement received build orders at the enterprise end.

The invention in the form of a method for managing material requirements is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. An accurate production method relates to a method that employs to proceed the operation of managing and controlling inventory stocks and productions of at least one facility through a material requirements planning server at an enterprise end on a material requirements system in the manufacturing industry. The method is to achieve the objects of timely handling productions of materials, decreasing the risk of a glut in the inventory center/stock house. The disclosed method includes at least the following steps:
Delivering a production order of the day into the material requirements planning server for calculation;
Generating an actual purchase order through the material requirements planning server;
Calculating the difference of the production order and a forecast order and generating a forecasted purchase order through the material requirements planning server;
Calculating a production quantity and a shortage of the day at the enterprise end; and
Forecasting the upcoming production quantity and the upcoming shortage.

2. The invention as recited in claim 1, wherein the forecast order is generated through the Enterprise Resource Planning (ERP) server based on procurement records provided by the client end to forecast required replenishment of quantities and material categories at the enterprise end at a predetermined interval.

3. The invention as recited in claim 1, wherein the production order relates to a build order placed by the client end at a predetermined interval.

4. The invention as recited in claim 1, wherein the method of delivering a production order of the day into the material requirements planning server for calculation is to contrast the production order with inventory stocks in the facility to generate a surplus stock and a shortage (stock-out).

5. The invention as recited in claim 4, wherein the surplus stock relates to a quantity where quantity of the production order is fewer than that of inventory stock in the facility.

6. The invention as recited in claim 4, wherein the shortage relates a quantity where the quantity of the production order is more than that of inventory stock in the facility, as a base of the actual purchase order.

7. The invention as recited in claim 1, wherein the actual purchase order is stored on a storage media with a marker to avoid being repeatedly calculated while the actual order is being processed the next time.

8. The invention as recited in claim 1, wherein the forecasted purchase order is the difference of the forecast order and the surplus stock.

9. The invention as recited in claim 1, wherein the production quantity and the shortage of the day both add up to be amount of the production order.

10. The invention as recited in claim 1, wherein the upcoming production quantity is generated through the material requirements planning server based on received production orders at a predetermined interval and further to calculate the average.

11. The invention as recited in claim 1, wherein the predetermined interval relates to a time set up by the material requirements planning server, based on requests of various client ends.

12. The invention as recited in claim 1, wherein the upcoming shortage is the sum of the actual purchase order and the forecasted purchase order.

13. The invention as recited in claim 1, wherein the facility is to distinguish production demands of various product models and to implement received build orders at the enterprise end.
